(19) United States
(12) Patent Application Publication
(10) Pub. No.: US 2026/0316271 A1
(43) Pub. Date: Oct. 15, 2026

(54) METHOD AND APPARATUS FOR CONTROLLING MOVEMENT OF ROBOT USING COLLISION AVOIDANCE SYSTEM FOR OBJECT

(71) Applicants: HYUNDAI MOTOR COMPANY, Seoul (KR); Kia Corporation, Seoul (KR); SUNGSHIN WOMEN’S UNIVERSITY R&DB FOUNDATION, Seoul (KR)

(72) Inventors: Jaehoon YOU, Hwaseong-si (KR); Won Hee KIM, Hwaseong-si (KR); Soomin SHIM, Hwaseong-si (KR); Seong Wook HWANG, Seoul (KR); Joon Young KIM, Seoul (KR); Namgyo KIM, Chuncheon-si (KR); Young Eun KIM, Bucheon-si (KR); Bo Kyung KIM, Daejeon (KR); Gyeongbin RYOO, Seoul (KR); Jeong Min OH, Seoul (KR); Ji Soo KANG, Seoul (KR)

(21) Appl. No.: 19/406,194

(22) Filed: Dec. 2, 2025

(30) Foreign Application Priority Data
Apr. 10, 2025 (KR) 10-2025-0046558

(51) Int. Cl. B25J 9/16; B25J 13/08

(52) U.S. Cl. CPC B25J 9/1666; B25J 9/1697; B25J 13/089

(57) ABSTRACT

A method of controlling a robot includes acquiring target object information regarding a target object within a predetermined target area of a building, the target object information including an image and measurable physical properties of the target object, classifying the target object into one of a predictable object or an unpredictable object by inputting the target object information into a pre-trained artificial intelligence model, determining collision risk information for the target object based on the classification of the target object, and controlling movement of the robot based on the collision risk information.

### CROSS-REFERENCE TO RELATED APPLICATION

This application claims priority to and the benefit of Korean Patent Application No. 10-2025-0046558 filed with the Korean Intellectual Property Office on Apr. 10, 2025, the entire contents of which are incorporated herein by reference.

### TECHNICAL FIELD

The present disclosure relates to a method and apparatus for controlling a robot by using a collision avoidance system for an object.

### BACKGROUND

Autonomous robot technology has been used in various industries and service fields with recent advances in artificial intelligence and sensor technology.

Conventional autonomous robots mainly use sensors, such as LiDAR, radar, ultrasonic sensors, and cameras, to recognize the surrounding environment, detect obstacles, and perform path planning and movement control based on the recognized surrounding environment and the detected obstacle.

Typically, these robots process data collected through built-in sensors in real time to avoid obstacles or move to a designated destination.

However, because conventional technology tends to rely solely on the robot's onboard sensors and recognizes objects and establishes avoidance strategies only within the range of the robot's direct sensing range, it is difficult to effectively respond to unpredictable risk factors in dynamic environments, such as obstacles approaching from outside the robot's field of view.

Furthermore, since conventional technology performs collision avoidance or path setting based on the location of a static obstacle or the expected movement trajectory of a dynamic obstacle, the accuracy of collision avoidance for dynamic obstacles of which movement is not predicted is insufficient.

Accordingly, there is a need to develop a technology to control the robot so that safer and more efficient movement is possible for objects that are not in the robot's field of view or whose movement is not predicted.

### SUMMARY

The present disclosure is directed to a method of obtaining target object information about an image and measurable physical properties of a target object by using a camera and a robot's sensor that captures the entire target site where a robot moves, and to determine predictability of the movement of the target object by using an artificial intelligence model trained based on the target object information.

The present disclosure is directed to a method of classifying a target object into a predictable object or an unpredictable object according to predictability of a movement of the target object, and controlling movement of the robot based on a collision risk level calculated through the classification of the target object.

According to one aspect of the present disclosure, a method of controlling a robot can include acquiring target object information regarding a target object within a predetermined target area of a building, the target object information including an image and measurable physical properties of the target object, classifying the target object into one of a predictable object or an unpredictable object by inputting the target object information into a pre-trained artificial intelligence model, determining collision risk information for the target object based on the classification of the target object, and controlling movement of the robot based on the collision risk information.

In some implementations, acquiring the target object information can include acquiring at least one of an image, number, size, position, movement direction, rotation radius, speed, acceleration, movement frequency, available space ratio, density, or movement path complexity of the target object by using at least one of (i) a camera configured to capture the entire target area or (ii) a sensor mounted on the robot configured to move within the target area. In some implementations, the pre-trained artificial intelligence model can be configured to receive an image of the target object and determine a category to which the target object belongs, and the category to which the target object belongs can be updated based on an image of the target object acquired at predetermined time intervals or data related to the building stored at a cloud.

In some examples, the pre-trained artificial intelligence model can include an object detection model and an object classification model, and classifying the target object into one of the predictable object or the unpredictable object can include determining a type of the target object by inputting the image of the target object into the object detection model, classifying the type of the target object by inputting the image of the target object into the object classification model, and classifying the target object into one of the predictable object or the unpredictable object based on (i) the type of the target object and (ii) the type of the target object belonging to the category. In some examples, classifying the target object into one of the predictable object or the unpredictable object can include classifying the target object into one of the predictable object or the unpredictable object based on speed or movement direction of the target object.

In some implementations, determining the collision risk information for the target object can include determining a collision risk level based on a weighted sum operation for movement frequency, mobility feasibility, and size of the target object, and determining a collision risk class corresponding to the determined collision risk level among at least one collision risk class each associated with a predetermined range of collision risk levels. In some examples, determining the collision risk level can include determining the collision risk level by applying different operation weights according to the classification of the target object.

In some implementations, the mobility feasibility can be determined based on a weighted sum operation for an available space ratio, density, movement path complexity, acceleration, and rotation radius of the target object. In some implementations, the collision risk level can be determined for a target object located within a preset radius from a position of the robot. In some implementations, controlling the movement of the robot based on the collision risk information can include controlling the movement of the robot based on a preset collision avoidance mechanism corresponding to the collision risk class.

According to another aspect of the present disclosure, an apparatus for controlling a robot can include a memory storing one or more instructions, and a processor configured to execute the instructions to perform operations. The operations can include acquiring target object information regarding a target object within a predetermined target area of a building, the target object information including an image and measurable physical properties of the target object, classifying the target object into one of a predictable object or an unpredictable object by inputting the target object information into a pre-trained artificial intelligence model, determining collision risk information for the target object based on the classification of the target object, and controlling movement of the robot based on the collision risk information.

In some implementations, acquiring the target object information can include acquiring at least one of an image, number, size, position, movement direction, rotation radius, speed, acceleration, movement frequency, available space ratio, density, or movement path complexity of the target object by using at least one of (i) a camera configured to capture the entire target area or (ii) a sensor mounted on the robot configured to move within the target area. In some implementations, the pre-trained artificial intelligence model can include an object detection model and an object classification model, and classifying the target object into one of the predictable object or the unpredictable object can include determining a type of the target object by inputting the image of the target object into the object detection model, classifying the type of the target object by inputting the image of the target object into the object classification model, and classifying the target object into one of the predictable object or the unpredictable object based on (i) the type of the target object and (ii) the type of the target object belonging to a category.

In some examples, classifying the target object into one of the predictable object or the unpredictable object can include classifying the target object into one of the predictable object or the unpredictable object based on speed or movement direction of the target object. In some implementations, determining the collision risk information for the target object can include determining a collision risk level based on a weighted sum operation for movement frequency, mobility feasibility, and size of the target object, and determining a collision risk class corresponding to the determined collision risk level among at least one collision risk class each associated with a predetermined range of collision risk levels.

In some examples, determining the collision risk level can include determining the collision risk level by applying different operation weights according to the classification of the target object. In some implementations, the mobility feasibility can be determined based on a weighted sum operation for an available space ratio, density, movement path complexity, acceleration, and rotation radius of the target object.

In some implementations, the collision risk level can be determined for a target object located within a preset radius from a position of the robot. In some implementations, controlling the movement of the robot based on the collision risk information can include controlling the movement of the robot based on a preset collision avoidance mechanism corresponding to the collision risk class.

According to another aspect of the present disclosure a non-transitory computer-readable recording medium stores a computer program, where execution of the computer program can cause a processor to perform operations comprising acquiring target object information regarding a target object within a predetermined target area of a building, the target object information including an image and measurable physical properties of the target object, classifying the target object into one of a predictable object or an unpredictable object by inputting the target object information into a pre-trained artificial intelligence model, determining collision risk information for the target object based on the classification of the target object, and controlling movement of a robot based on the collision risk information.

### BRIEF DESCRIPTION OF THE DRAWINGS

FIG. 1 is a block diagram illustrating an example of an apparatus for controlling robot movement.

FIG. 2 is a block diagram conceptually illustrating an example of a function of a robot movement control program.

FIG. 3 is a flowchart illustrating an example of a method of controlling the movement of the robot by using a collision avoidance system.

FIG. 4 is a diagram illustrating an example of a structure of a collision avoidance system.

FIG. 5 is a diagram illustrating an example of a pre-trained artificial intelligence model.

FIG. 6 is a diagram illustrating an example of controlling the movement of a robot based on an interworking between an object avoidance platform and a robot.

FIG. 7 is a flowchart illustrating an example of controlling the movement of the robot with reference to collision risk information on a target object.

### DETAILED DESCRIPTION

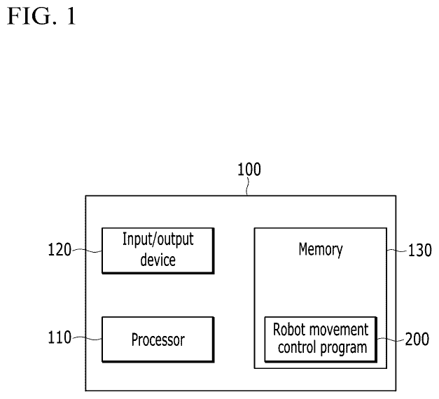

FIG. 1 is a block diagram illustrating an example of an apparatus for controlling robot movement.

Referring to FIG. 1, a robot movement control apparatus 100 can include a processor 110, an input/output device 120, and a memory 130.

The processor 110 can control the overall operation of the robot movement control apparatus 100.

The processor 110 can receive at least one of information regarding a predetermined target area in a building or target object information including an image and measurable physical properties of a target object within the target are by using the input/output device 120.

In the present specification, for convenience of description, the present disclosure has been described based on the case where at least one of information regarding the predetermined target area in the building and the target object information including the image and measurable physical properties of the target object within the target area is input through the input/output device 120 as an example, but is not limited thereto. For example, the robot movement control apparatus 100 can include a transceiver, and the robot movement control apparatus 100 can receive at least one of information regarding a predetermined target area in a building or target object information including an image and measurable physical properties of a target object within the target area by using a transceiver, and at least one of information regarding a predetermined target area in a building or information regarding a target object including an image and measurable physical properties of a target object within the target area can be collected or generated within the robot movement control apparatus 100.

The processor 110 can acquire target object information including an image and measurable physical properties of the target object within a predetermined target area in a building, input the target object information to a pre-trained artificial intelligence model and classify the target object into one of a predictable object or an unpredictable object, determine collision risk information for the target object based on the classification of the target object, and control the robot's movement based on the collision risk information.

The input/output device 120 can include one or more input devices and/or one or more output devices. For example, the input device can include a microphone, a keyboard, a mouse, a touch screen, and the like, and the output device can include a display, a speaker, and the like.

The memory 130 can store the robot movement control program 200 and information for the execution of the robot movement control program 200.

In some implementations, the robot movement control program 200 can refer to software including instructions for controlling the movement of the robot by referring to collision risk information regarding a target object determined based on target object information obtained through a robot movement on a target area in a building.

The processor 110 can load the robot movement control program 200 and information for the execution of the robot movement control program 200 from the memory 130, and execute the robot movement control program 200.

The processor 110 can acquire target object information including an image and measurable physical properties of the target object within a predetermined target area in a building, input the target object information to a pre-trained artificial intelligence model and classify the target object into one of a predictable object or an unpredictable object, determine collision risk information for the target object based on the classification of the target object, and control the robot's movement based on the collision risk information by executing the robot movement control program 200.

In some implementations, the robot can refer to an autonomous robot that moves on at least one floor, area, or space constituting a specific building and performs a predetermined task (e.g., delivery, cleaning).

In some implementations, a building may refer to an intelligent building that utilizes technologies, such as Internet of Things (IoT) sensors, artificial intelligence (AI), and automation systems. For example, the building can be interlocked with a data cloud system centered on architectural information modeling (BIM) data, and can share updated information with the robot in real time through real-time monitoring of the interior and exterior environment of the building.

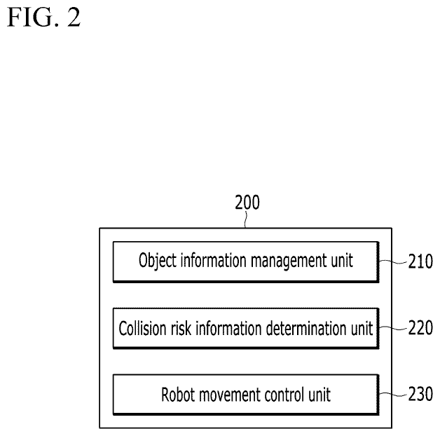

Functions and/or operations of the robot movement control program 200 will be described in detail with reference to FIG. 2.

FIG. 2 is a block diagram conceptually illustrating an example of a function of the robot movement control program.

Referring to FIG. 2, the robot movement control program 200 can include an object information management unit 210, a collision risk information determination unit 220, and a robot movement control unit 230.

The object information management unit 210, the collision risk information determination unit 220, and the robot movement control unit 230 illustrated in FIG. 2 are based on the conceptually divided functions of the robot movement control program 200 to easily describe the functions of the robot movement control program 200, and the present disclosure is not limited thereto. In some implementations, the functions of the object information management unit 210, the collision risk information determination unit 220, and the robot movement control unit 230 can be merged/separable and can be implemented as a series of instructions included in one program.

First, the object information management unit 210 can acquire target object information including an image and measurable physical properties of a target object within a predetermined target area in a building.

For example, the predetermined target area can refer to an area corresponding to a floor on which the robot moves in a building. In addition, the target object can include a static obstacle and a dynamic obstacle that occupy or are scheduled to occupy the target area.

In some implementations, the object information management unit 210 can acquire at least one of an image, number, size, position, movement direction, rotation radius, speed, acceleration, frequency of motion, available space ratio, density, or movement path complexity of the target object by using at least one of a camera (e.g., CCTV camera) that captures the entire target area and a sensor mounted on a robot moving within the target area (e.g., camera sensor, lidar).

Here, the available space ratio can refer to an area for the robot's movable area with respect to the total space area, and a parameter indicating a ratio to a space in which the robot may move in consideration of the size of the robot.

In addition, the movement path complexity can refer to an actual movement distance with respect to the shortest movement distance, and a parameter representing a ratio of the complexity of a path on which a robot can move.

Thus, by using a camera that captures the entire target area as well as a sensor mounted on the robot, it is possible to acquire target object information about the image and measurable physical properties of the target object outside the robot's field of view.

In some implementations, the object information management unit 210 can input the target object information into a pre-trained artificial intelligence model to classify the target object into one of a predictable object or an unpredictable object.

The pre-trained artificial intelligence model can include an object detection model (e.g., YOLO, Faster R-CNN) for recognizing a target object and an object classification model (e.g., ResNet, EfficientNet) for classifying the type of the target object, and can be trained to receive an image of the target object to determine a category to which the target object belongs.

Here, the category can refer to the sort and type of a target object (e.g., a person (adult), a person (child), a mobile robot, a mobile tray)) with predictability for movement.

For example, the object information management unit 210 can classify the target object into one of a predictable object or an unpredictable object according to whether the target object belongs to a category set based on predictability of the movement of the target object by using the pre-trained artificial intelligence model.

By way of further example, the object information management unit 210 can determine the type of the target object (e.g., a person, an animal) by inputting the image of the target object to the object detection model.

In some implementations, the object information management unit 210 can determine the type of the target object (e.g., adult, children) by inputting the image of the target object into the object classification model.

In some implementations, the object information management unit 210 can classify the target object into one of a predictable object or an unpredictable object by referring to whether at least one of the type of the target object or the kind of the target object falls under the category.

In some implementations, the category to which the target object belongs can be updated based on an image of the target object or a data cloud for a building obtained at predetermined time intervals.

In some implementations, the category to which the target object belongs can be set by the user, or updated based on the target object that is unclassified according to the inference of the pre-trained artificial intelligence model.

In some implementations, the object information management unit 210 can further refer to the speed or movement direction of the target object to classify the target object into one of a predictable object and an unpredictable object.

When the target object has been classified as a predictable object through the pre-trained artificial intelligence model, the object information management unit 210 can classify the target object as an unpredictable object when the speed or movement direction of the target object is rapidly changed and has a rate of change beyond a preset value (e.g., when a specific adult runs in a walking space in a building, or when a past movement pattern and a current movement pattern of a specific adult are different).

As such, by primarily determining the predictability of the movement of the target object based on the type and sort of object identified through the pre-trained artificial intelligence model and secondarily determining the predictability of the movement of the target object by further referring to the speed or movement direction of the target object, a unique effect of conservatively determining collision risk information for the target object to be described later in a dynamic environment can be achieved.

Next, the collision risk information determination unit 220 can determine collision risk information regarding the target object based on the classification of the target object. Here, the collision risk information can include a collision risk level obtained by quantifying the collision possibility between the target object and the robot, and a collision risk class corresponding to a preset collision avoidance mechanism of a robot classified according to the collision risk level.

For example, the collision risk information determination unit 220 can determine the collision risk level based on a weighted sum operation for the movement frequency, mobility feasibility, and size of the target object, and, for example, the collision risk can be expressed as Equation 1 below.

f(⋅)=1+ax+by+cz (Equation 1)

Here, f(⋅) can refer to a collision risk level, a can refer to an operation weight for the movement frequency x of the target object, b can refer to an operation weight for the mobility feasibility y of the target object, and c can refer to an operation weight for the size z of the target object.

In some implementations, in calculating the collision risk level, the collision risk information determination unit 220 can apply different operation weights according to the classification of the target object.

For example, when the target object is a predictable object, the collision risk information determination unit 220 can determine the collision risk level by setting the operation weight for the movement frequency of the target object, the operation weight for the mobility feasibility of the target object, and the operation weight for the size of the target object to 1.

In another example, when the target object is an unpredictable object, the collision risk information determination unit 220 can determine a higher collision risk level than that of the predictable object by setting the operation weight for the motion frequency of the target object, the operation weight for the mobility feasibility of the target object, and the operation weight for the size of the target object to 1.2. Here, the operation weight can be set differently in consideration of the influence on each factor of the motion frequency, mobility feasibility, and size of the target object.

As described above, in the present disclosure, the movement of the robot can be controlled more safely by calculating the collision risk level by applying the operation weight conservatively added compared to the predictable object to the unpredictable object.

The operation weight set for the unpredictable object is only an example, and may be variously changed within a range capable of achieving the object of the present disclosure.

Also, the collision risk level can be determined with respect to a target object located within a preset radius from the position of the robot. Accordingly, unnecessary waste of computing resources can be reduced by calculating a collision risk level for a target object having a high probability of collision with the robot in the target site.

In some cases, the mobility feasibility of the target object may be determined based on a weighted sum operation on the available space ratio, density, movement path complexity, acceleration, and rotation radius.

For example, the mobility feasibility of the target object can refer to a mobility feasibility score (MFS) or a probability converted through normalization of the mobility feasibility score. A mobility feasibility score can be expressed as Equation 2 below.

$$MFS = {w}_{1} \cdot ASR + {w}_{2} \cdot \frac{1}{OD} + {w}_{3} \cdot \frac{1}{P C} + {w}_{4} \cdot \frac{{A}_{max}}{{A}_{ref}} + {w}_{5} \cdot \frac{{R}_{ref}}{{R}_{min}} \qquad ( Equation 2 )$$

Here, MFS can refer to a mobility feasibility score, OD can refer to at least one obstacle density occupying the target site, PC can refer to the movement path complexity of the target object, Aₘₐₓ can refer to the maximum acceleration of the target object, and Rₘᵢₙ can refer to the minimum rotation radius of the target object.

In addition, the collision risk information determination unit 220 can determine a collision risk class corresponding to the determined collision risk level among at least one collision risk class having a predetermined collision risk range.

For example, each collision risk class is the classification of the collision risk level based on a predetermined range, and, as the collision risk class increases, the collision avoidance mechanism corresponding to the collision risk class can be set to increase the avoidance radius and avoidance distance of the robot.

For example, when the collision risk level is greater than or equal to 1 and less than 4.9, the collision risk information determination unit 220 can determine the collision risk class as index 1. When the collision risk level is greater than or equal to 4.9 and less than 9.8, the collision risk information determination unit 220 can determine the collision risk class as index 2. Here, the avoidance radius and avoidance distance of the robot included in index 2 may be greater than those included in index 1.

In some implementations, the collision avoidance mechanism can be described in terms of the avoidance radius and avoidance distance, but the index for collision avoidance may be variously changed within a range capable of achieving the purpose of the present disclosure.

In some implementations, the robot movement control unit 230 can control the movement of the robot by referring to collision risk information regarding the target object.

For example, the robot movement control unit 230 can control the movement of the robot according to a preset collision avoidance mechanism corresponding to the collision risk class.

For example, when the collision risk class is determined as 2, the robot movement control unit 230 can control the movement of the robot based on a command to “avoid left and right sides at 0.7 m intervals within a radius of 2.5 m” according to the collision avoidance mechanism corresponding to index 2.

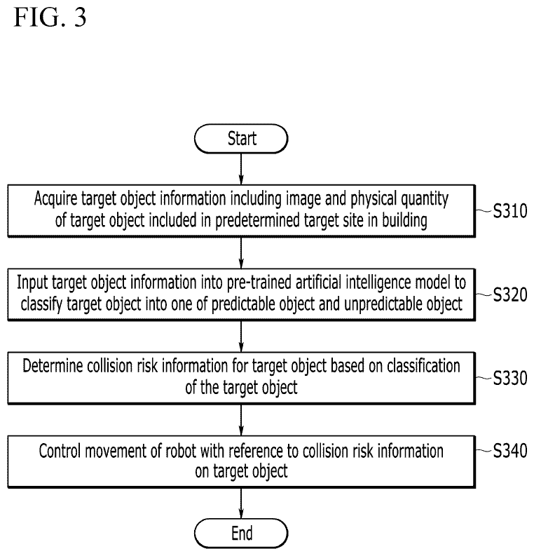

FIG. 3 is a flowchart illustrating an example of a method of controlling the movement of the robot by using a collision avoidance system.

Referring to FIG. 3, the object information management unit 210 can acquire target object information including an image and measurable physical properties of a target object within a predetermined target area in a building (S310).

Then, the object information management unit 210 can input the target object information into a pre-trained artificial intelligence model to classify the target object into one of a predictable object or an unpredictable object (S320).

Then, the collision risk information determination unit 220 can determine collision risk information for the target object based on the classification of the target object (S330).

Next, the robot movement control unit 230 can control the movement of the robot with reference to the collision risk information regarding the target object (S340).

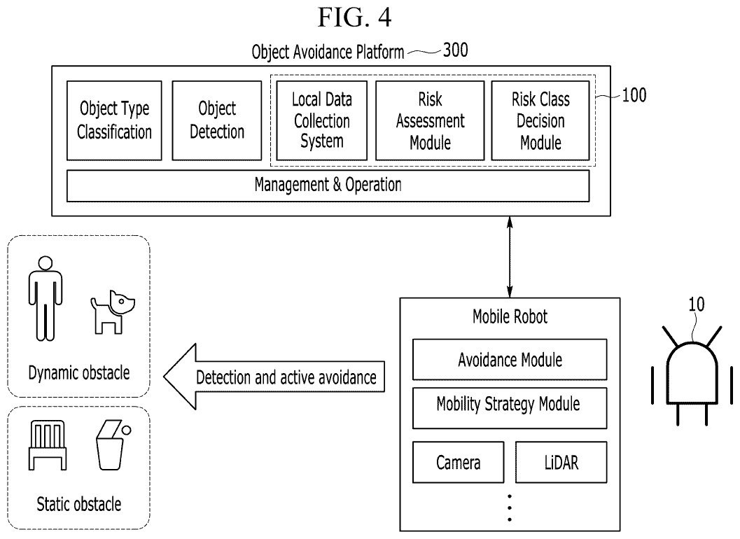

FIG. 4 is a diagram illustrating an example of a structure of the collision avoidance system.

Referring to FIG. 4, the collision avoidance system can include a robot 10 and an object avoidance platform 300 that is interlocked with the robot 10. The robot movement control apparatus 100 can be interlocked with the object avoiding platform 300 or can be embedded in the robot 10. Hereinafter, the present disclosure will be described on the premise that the robot movement control apparatus 100 is interlocked with the object avoiding platform 300.

The object avoidance platform 300 can include an object classification model for classifying the type of a target object, an object detection model for detecting the type of the target object, a local data collection system for collecting target object information including an image and measurable physical properties of the target object within a predetermined target site, a risk assessment module for determining a collision risk level, and a risk class determination module for determining a collision risk class.

The robot movement control apparatus 100 can acquire target object information by using the local data collection system. Also, the robot movement control apparatus 100 can classify the target object into a predictable object or an unpredictable object by using the object classification model and the object detection model. Also, the robot movement control apparatus 100 can determine a collision risk level and a collision risk class with respect to the target object using a risk assessment module and the risk class determination module.

The robot 10 can include an avoidance module, a movement strategy module, and a sensor (e.g., a camera, a lidar). Here, the robot 10 can receive the collision risk class through interworking with the object avoidance platform 300. Also, the robot 10 can be controlled to avoid a dynamic obstacle and a static obstacle included in the target area according to a collision avoidance mechanism corresponding to the collision risk class by using a movement strategy module.

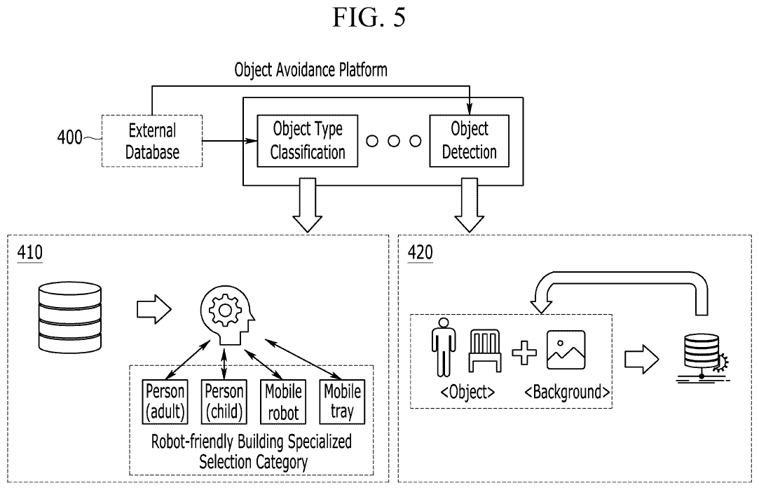

FIG. 5 is a diagram exemplarily illustrating an example of a pre-trained artificial intelligence model.

FIG. 5 illustrates an object detection model included in the object avoidance platform and an external database 400 for training an object detection model.

The external database 400 can store an object classification model and data for algorithm training an object detection model. For example, the external database 400 can store an image (e.g., an image for a target object and an image for a background) acquired through a camera in a building that capture the entire target area and a sensor mounted on a robot that moves within the target area, and a category corresponding to the image.

In addition, the external database 400 can be interworked with a data cloud system centered on building information modeling (BIM) data and store target object information updated through real-time monitoring of the interior and exterior environment of the building.

In some implementations, the object classification model can be trained to receive an image of the target object and classify the image into a category (e.g., a person (adult), a person (child), a mobile robot, a pet, a mobile tray) to which the target object belongs (410).

In addition, the object detection model can be trained to segment an object and background from the image of the target object, and receive synthesized images obtained by combining and synthesizing the objects and backgrounds to detect an object (420).

In some implementations, the object detection model can be trained until the recognition accuracy of the object exceeds 95%. When the recognition accuracy is not achieved, the object detection model can be retrained to detect an object by receiving a synthesized image in which the object and the background are combined and additionally synthesized.

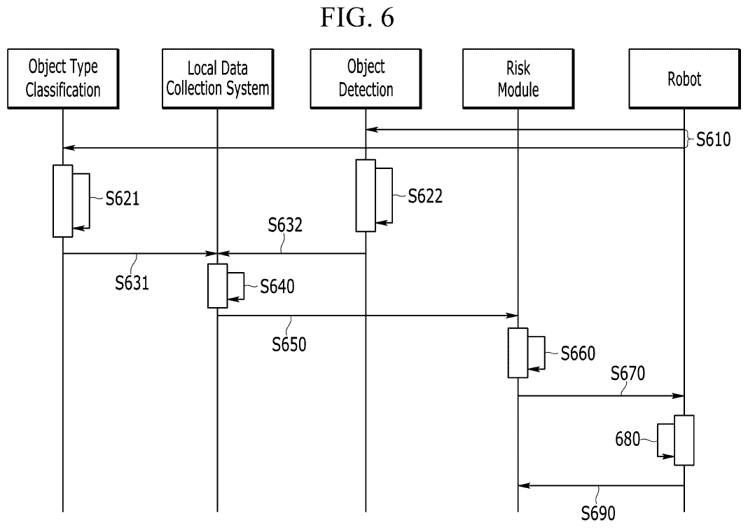

FIG. 6 is a diagram illustrating an example of controlling the movement of a robot based on an interworking between the object avoidance platform and the robot.

Referring to FIG. 6, the robot can transmit target object information including an image photographed by a built-in sensor and physical quantity data measured by the sensor to the object avoidance platform (S610).

Then, the object classification model and the object detection model can be used to derive a result value (e.g., a result value of recognizing the type of the target object or classifying the type of the target object) (S621, S622) obtained by receiving, analyzing, and processing the target object information. In addition, the object classification model and the object detection model can transmit the result value to the local data collection system (S631, S632).

Then, the local data collection system can classify the target object through an analysis of the result value and determine a parameter value derived from the physical quantity data of the target object (S640).

Then, the local data collection system can transmit the parameter value to the risk module (including the risk assessment module and the risk class determination module) (S650).

Then, the risk module can calculate a collision risk level based on the received parameter value and determine a collision risk class (S660).

Next, the risk module can transmit the index value of the collision risk class to the robot (S670).

Next, the robot can perform avoidance control on the target object based on the avoidance radius and the avoidance distance corresponding to the index value of the collision risk class (S680).

Next, the robot can transmit the avoidance control result to the risk module (S690). For example, feedback on the collision risk level and the collision risk class determined in the risk module based on the avoidance control result can be performed, and optimal avoidance control for a target object included in a predetermined target site can be performed.

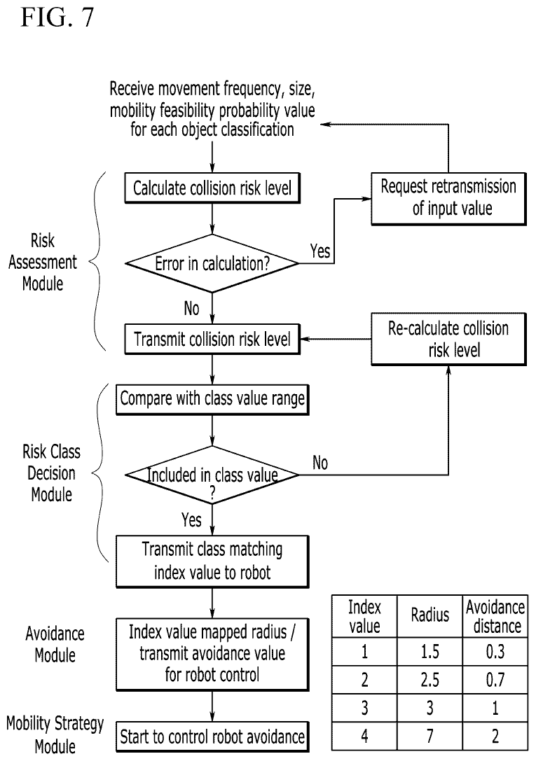

FIG. 7 is a flowchart illustrating an example of controlling the movement of the robot with reference to the determined collision risk information.

Referring to FIG. 7, the risk assessment module can calculate a collision risk level by receiving parameters regarding the mobility frequency, size, and mobility feasibility probability value for each object classification from the local data collection system.

In some implementations, when there is a calculation error, the risk assessment module can request the local collection system to retransmit the input parameter value. Also, when there is no calculation error, the risk assessment module can transmit the collision risk level to the risk class determination module.

Next, the risk class determination module can compare the calculated collision risk level with at least one collision risk class having a predetermined range to determine a collision risk class to which the collision risk level belongs to. For example, when a value is not included in at least one collision risk class, the collision risk level can be recalculated.

In addition, when the collision risk level is included in at least one collision risk class, the risk class determination module can transmit a class matching index value to the robot's avoidance module.

For example, when the collision risk level is greater than or equal to 1 and less than 4.9, the index value corresponding to the collision risk class can be 1. Also, when the collision risk level is greater than or equal to 4.9 and less than 9.8, the index value can be 2. Also, when the collision risk level is greater than or equal to 9.8 and less than 14.7, the index value can be 3. Also, when the collision risk level is greater than or equal to 14.7, the index value can be 4.

Then, the avoidance module of the robot can transmit the robot control value regarding the avoidance radius and avoidance distance mapped to the index value to the movement strategy module.

For example, when the index value corresponding to the collision risk class is 1, the avoidance radius of the robot can be 1.5 m and the avoidance distance can be 0.3 m. Also, when the index value is 2, the avoidance radius of the robot can be 2.5 m and the avoidance distance can be 0.7 m. Also, when the index value is 3, the avoidance radius of the robot can be 3 m and the avoidance distance can be 1 m. Also, when the index value is 4, the avoidance radius of the robot can be 7 m and the avoidance distance can be 2 m.

Next, the movement strategy module of the robot can perform robot control according to an avoidance radius and an avoidance distance mapped to the index value.

The range of collision risk level corresponding to the index value and the avoidance radius and avoidance distance value corresponding to the index value are only examples, and may be variously changed within a range capable of achieving the purpose of the present disclosure.

Combinations of each block in the block diagram and each step in the flowchart attached to the present disclosure can be performed by computer program instructions. These computer program instructions can be mounted on an encoding processor of a general-purpose computer, special-purpose computer, or other programmable data processing equipment, so that the instructions performed through the encoding processor of a computer or other programmable data processing equipment create a means to perform the functions described in each block of the block diagram or in each step of the flowchart. These computer program instructions can be stored in computer-available or computer-readable memory that can be directed to a computer or other programmable data processing equipment to implement functions in a specific way, so the instructions stored in the computer-available or computer-readable memory can produce manufactured items containing instructions that perform the functions described in each block or flowchart of the block diagram. The computer program instructions can also be mounted on a computer or other programmable data processing equipment, so that the instructions for performing a computer or other programmable data processing equipment by performing a series of operational steps on a computer or other programmable data processing equipment to create a computer-executed process may provide operations for executing functions described in each block of the block diagram and each step of the flowchart.

Further, each block or each step can represent a portion of modules, segments, or codes including one or more executable instructions for executing specified logical function(s). It should also be noted that in some alternative exemplary implementations, it is also possible for the functions mentioned in blocks or steps to occur out of order. For example, it is possible that two blocks or steps illustrated one after another may in fact be performed substantially simultaneously, or that the blocks or steps may sometimes be performed in the reverse order according to the corresponding function.

What is claimed is:

1. A method of controlling a robot, the method comprising:
acquiring target object information regarding a target object within a predetermined target area of a building, the target object information including an image and measurable physical properties of the target object;
classifying the target object into one of a predictable object or an unpredictable object by inputting the target object information into a pre-trained artificial intelligence model;
determining collision risk information for the target object based on the classification of the target object; and
controlling movement of the robot based on the collision risk information.

2. The method of claim 1, wherein acquiring the target object information includes:
acquiring at least one of an image, number, size, position, movement direction, rotation radius, speed, acceleration, movement frequency, available space ratio, density, or movement path complexity of the target object by using at least one of (i) a camera configured to capture the entire target area or (ii) a sensor mounted on the robot configured to move within the target area.

3. The method of claim 1, wherein the pre-trained artificial intelligence model is configured to receive an image of the target object and determine a category to which the target object belongs, and
wherein the category to which the target object belongs is updated based on an image of the target object acquired at predetermined time intervals or data related to the building stored at a cloud.

4. The method of claim 3, wherein:
the pre-trained artificial intelligence model includes an object detection model and an object classification model, and
classifying the target object into one of the predictable object or the unpredictable object includes:
determining a type of the target object by inputting the image of the target object into the object detection model,
classifying the type of the target object by inputting the image of the target object into the object classification model, and
classifying the target object into one of the predictable object or the unpredictable object based on (i) the type of the target object and (ii) the type of the target object belonging to the category.

5. The method of claim 4, wherein classifying the target object into one of the predictable object or the unpredictable object includes:
classifying the target object into one of the predictable object or the unpredictable object based on speed or movement direction of the target object.

6. The method of claim 1, wherein determining the collision risk information for the target object includes:
determining a collision risk level based on a weighted sum operation for movement frequency, mobility feasibility, and size of the target object, and
determining a collision risk class corresponding to the determined collision risk level among at least one collision risk class each associated with a predetermined range of collision risk levels.

7. The method of claim 6, wherein determining the collision risk level includes:
determining the collision risk level by applying different operation weights according to the classification of the target object.

8. The method of claim 6, wherein the mobility feasibility is determined based on a weighted sum operation for an available space ratio, density, movement path complexity, acceleration, and rotation radius of the target object.

9. The method of claim 6, wherein the collision risk level is determined for a target object located within a preset radius from a position of the robot.

10. The method of claim 6, wherein controlling the movement of the robot based on the collision risk information includes:
controlling the movement of the robot based on a preset collision avoidance mechanism corresponding to the collision risk class.

11. An apparatus for controlling a robot, the apparatus comprising:
a memory storing one or more instructions; and
a processor configured to execute the instructions to perform operations comprising:
acquiring target object information regarding a target object within a predetermined target area of a building, the target object information including an image and measurable physical properties of the target object,
classifying the target object into one of a predictable object or an unpredictable object by inputting the target object information into a pre-trained artificial intelligence model,
determining collision risk information for the target object based on the classification of the target object, and
controlling movement of the robot based on the collision risk information.

12. The apparatus of claim 11, wherein acquiring the target object information includes:
acquiring at least one of an image, number, size, position, movement direction, rotation radius, speed, acceleration, movement frequency, available space ratio, density, or movement path complexity of the target object by using at least one of (i) a camera configured to capture the entire target area or (ii) a sensor mounted on the robot configured to move within the target area.

13. The apparatus of claim 11, wherein:
the pre-trained artificial intelligence model includes an object detection model and an object classification model, and
classifying the target object into one of the predictable object or the unpredictable object includes:
determining a type of the target object by inputting the image of the target object into the object detection model,
classifying the type of the target object by inputting the image of the target object into the object classification model, and
classifying the target object into one of the predictable object or the unpredictable object based on (i) the type of the target object and (ii) the type of the target object belonging to a category.

14. The apparatus of claim 13, wherein classifying the target object into one of the predictable object or the unpredictable object includes:
classifying the target object into one of the predictable object or the unpredictable object based on speed or movement direction of the target object.

15. The apparatus of claim 11, wherein determining the collision risk information for the target object includes:
determining a collision risk level based on a weighted sum operation for movement frequency, mobility feasibility, and size of the target object, and
determining a collision risk class corresponding to the determined collision risk level among at least one collision risk class each associated with a predetermined range of collision risk levels.

16. The apparatus of claim 15, wherein determining the collision risk level includes:
determining the collision risk level by applying different operation weights according to the classification of the target object.

17. The apparatus of claim 15, wherein the mobility feasibility is determined based on a weighted sum operation for an available space ratio, density, movement path complexity, acceleration, and rotation radius of the target object.

18. The apparatus of claim 15, wherein the collision risk level is determined for a target object located within a preset radius from a position of the robot.

19. The apparatus of claim 15, wherein controlling the movement of the robot based on the collision risk information includes:
controlling the movement of the robot based on a preset collision avoidance mechanism corresponding to the collision risk class.

20. A non-transitory computer-readable recording medium storing a computer program, wherein execution of the computer program causes a processor to perform operations comprising:
acquiring target object information regarding a target object within a predetermined target area of a building, the target object information including an image and measurable physical properties of the target object;
classifying the target object into one of a predictable object or an unpredictable object by inputting the target object information into a pre-trained artificial intelligence model;
determining collision risk information for the target object based on the classification of the target object; and
controlling movement of a robot based on the collision risk information.
